(19) United States
(12) Patent Application Publication
(10) Pub. No.: US 2019/0064951 A1
(43) Pub. Date: Feb. 28, 2019

(54) TOUCH SUBSTRATE AND DISPLAY DEVICE

(71) Applicants: BOE Technology Group Co., Ltd., Beijing (CN); HEFEI XINSHENG OPTOELECTRONICS TECHNOLOGY CO., LTD, Anhui (CN)

(72) Inventor: Wenjuan Yang, Beijing (CN)

(21) Appl. No.: 15/957,024

(22) Filed: Apr. 19, 2018

(30) Foreign Application Priority Data
Aug. 31, 2017 (CN) 201721109328.2

(51) Int. Cl. G06F 3/041

(52) U.S. Cl. CPC G06F 3/041; G06F 2203/04103

(57) ABSTRACT

A touch substrate and a display device are provided in the embodiments of the disclosure, both belonging to the technical fields of display apparatus. The touch substrate includes: a base substrate; a first pattern blanking layer, provided on the base substrate; and a touch layer, provided between the base substrate and the first pattern blanking layer, the touch layer being provided at a side thereof facing away from the base substrate a second pattern blanking layer.

### CROSS-REFERENCE TO RELATED INVENTION

The present disclosure claims the benefit of Chinese Patent Application Invention No. 201721109328.2 filed on Aug. 31, 2017 in the State Intellectual Property Office of China, the whole disclosure of which is incorporated herein by reference.

### BACKGROUND OF THE INVENTION

### Field of the Invention

Embodiments of the present disclosure pertain to the technical field of display apparatus, and especially to a touch substrate and a display device.

### Description of the Related Art

Touch panel is a display device which has both display functionality and instruction input functionality, and a user may get in direct contact with the touch panel by hand or object(s). The touch panel may then detect specific region on the touch panel which region is being touched by the user, and make a corresponding response depending on such region being touched. In present touch panels, an OGS (i.e., One Glass Solution) touch panel has a relatively wide range of application due to a relatively simple manufacturing process thereof.

The OGS touch panel comprises a display module, a touch layer and a protective glass stacked upon one another. The touch layer is formed directly on the protective glass. The touch layer is typically formed to have patterns thereof by a transparent conductive oxide using a process such as etching and the like. Since the touch layer of the OGS touch panel is provided on the protective glass, then a distance of the touch layer from a surface of the OGS touch panel is relative smaller than a thickness of the OGS touch panel, such that patterns of the touch layer which are not contents on the panel required to be observed by the user may also be perceived by human eyes once the touch layer is illuminated by ambient light. In order to avoid perception of such patterns on the touch layer by human eyes, there is an additional IM (i.e., Index matching) film (also referred to as pattern blanking film or shade eliminating film) provided between the touch layer and the protective glass, so as to decrease reflectance of the transparent conductive oxide and in turn to decrease visual contrasts between the patterns and other regions, resulting in faded lines of the patterns under irradiation of ambient light and in turn a blanking of patterns thereby.

### SUMMARY OF THE INVENTION

The embodiments of the present disclosure have been made to overcome or alleviate at least one aspect of the above mentioned disadvantages and/or shortcomings in the prior art, by providing a touch substrate and a display device.

Following technical solutions are adopted in exemplary embodiments of the invention for achieving the above desired technical purposes.

According to an aspect of the exemplary embodiment of the present disclosure, there is provided a touch substrate, comprising: a base substrate; a first pattern blanking layer, provided on the base substrate; and a touch layer, provided between the base substrate and the first pattern blanking layer, the touch layer being further provided at a side thereof facing away from the base substrate a second pattern blanking layer.

In an embodiment of the disclosure,wherein the first pattern blanking layer is in a periodic structure comprising at least a group of pattern blanking sub-layers, the second pattern blanking layer being a structure of a single layer.

In an embodiment of the disclosure, each group of pattern blanking sub-layers of the first pattern blanking layer comprises a first pattern blanking sub-layer and a second pattern blanking sub-layer overlapped with each other, the refractive index of each first pattern blanking sub-layer being larger than the refractive index of each second pattern blanking sub-layer; and in each group of pattern blanking sub-layers, the first pattern blanking sub-layer is arranged closer to the base substrate as compared with the second pattern blanking sub-layer.

In an embodiment of the disclosure, in a condition that the first pattern blanking layer comprises at least two groups of pattern blanking sub-layers, the first pattern blanking sub-layers in different groups of the pattern blanking sub-layers of the first pattern blanking layer are identical in their respective refractive indices and are different from one another in their respective geometric thicknesses, and the second pattern blanking sub-layers in different groups of the pattern blanking sub-layers of the first pattern blanking layer are identical in their respective refractive indices and are different from one another in their respective geometric thicknesses.

In an embodiment of the disclosure, each first pattern blanking sub-layer of the first pattern blanking layer is a NbO layer, and each second pattern blanking sub-layer of the first pattern blanking layer is a SiO₂ layer.

In an embodiment of the disclosure, the geometric thickness of each first pattern blanking sub-layer of the first pattern blanking layer is 40˜140 angstrom, and the geometric thickness of each second pattern blanking sub-layer of the first pattern blanking layer is 350˜450 angstrom.

In an embodiment of the disclosure, the second pattern blanking layer is a SiON layer.

In an embodiment of the disclosure, the geometric thickness of the second pattern blanking layer is 650˜750 angstrom.

In an embodiment of the disclosure, there is provided additionally a transmittance enhancement layer on the base substrate, the transmittance enhancement layer being located on a surface at a side of the base substrate.

In an embodiment of the disclosure, the transmittance enhancement layer is provided on the base substrate, on a surface thereof at a same side as the first pattern blanking layer, and is located between the first pattern blanking layer and the base substrate.

In an embodiment of the disclosure, the transmittance enhancement layer is provided on the base substrate, on a surface thereof at a side opposite to the first pattern blanking layer.

In an embodiment of the disclosure, the transmittance enhancement layer is in a periodic structure comprising at least a group of transmittance enhancement sub-layers, each group of the transmittance enhancement sub-layers comprises a first transmittance enhancement sub-layer and a second transmittance enhancement sub-layer overlapped with each other, the refractive index of each first transmittance enhancement sub-layer of the transmittance enhancement layer being larger than the refractive index of each second transmittance enhancement sub-layer of the transmittance enhancement layer, and in each group of transmittance enhancement sub-layers, the first transmittance enhancement sub-layer of the transmittance enhancement layer is arranged closer to the base substrate as compared with the second transmittance enhancement sub-layer.

In an embodiment of the disclosure, in a condition that the transmittance enhancement layer comprises at least two groups of transmittance enhancement sub-layers, the first transmittance enhancement sub-layers of different groups of transmittance enhancement sub-layers of the transmittance enhancement layer are identical in their respective refractive indices and are different from one another in their respective geometric thicknesses, and the second transmittance enhancement sub-layers of different groups of transmittance enhancement sub-layers of the transmittance enhancement layer are identical in their respective refractive indices and are different from one another in their respective geometric thicknesses.

In an embodiment of the disclosure, each first transmittance enhancement sub-layer of the transmittance enhancement layer is a NbO layer, and each second transmittance enhancement sub-layer of the transmittance enhancement layer is a SiO₂ layer.

In an embodiment of the disclosure, the transmittance enhancement layer comprises two groups of transmittance enhancement sub-layers.

In an embodiment of the disclosure, the geometric thickness of each first transmittance enhancement sub-layer is 140˜240 angstrom, and the geometric thickness of each second pattern blanking sub-layer is 190˜290 angstrom, in a first group of the transmittance enhancement sub-layers of the transmittance enhancement layer; geometric thickness of each first transmittance enhancement sub-layer is 1080˜1180 angstrom, and the geometric thickness of each second pattern blanking sub-layer is 780˜880 angstrom, in a second group of the transmittance enhancement sub-layers of the transmittance enhancement layer, and the first group of the transmittance enhancement sub-layers are arranged closer to the base substrate as compared with the second group of the transmittance enhancement sub-layers.

According to another aspect of the exemplary embodiment of the present disclosure, there is provided a display device, comprising the touch substrate as above.

### BRIEF DESCRIPTION OF THE DRAWINGS

The above and other features and advantages of the present disclosure will become more apparent and a more comprehensive understanding of the present disclosure can be obtained, by describing in detail exemplary embodiments thereof with reference to the accompanying drawings, in which:

FIG. 1 illustrates a structural schematic view of a touch substrate provided in embodiments of the disclosure;

FIG. 2 illustrates a structural schematic view of another touch substrate provided in embodiments of the disclosure;

FIG. 3 illustrates a structural schematic view of one more another touch substrate provided in embodiments of the disclosure;

FIG. 4 illustrates a structural schematic view of still another touch substrate provided in embodiments of the disclosure;

FIG. 5 illustrates a structural schematic view of yet another touch substrate provided in embodiments of the disclosure;

FIG. 6 illustrates a structural schematic view of still yet another touch substrate provided in embodiments of the disclosure.

### DETAILED DESCRIPTION OF EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms, and thus the detailed description of the embodiment of the disclosure in view of attached drawings should not be construed as being limited to the embodiment set forth herein; rather, these embodiments are provided so that the present disclosure will be thorough and complete, and will fully convey the general concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Since sizes of various structures as mentioned in embodiments of the disclosure are relatively tiny, respective dimension and shape of each component in the drawings are only intended to exemplarily illustrate the contents of the disclosure, rather than to demonstrate the practical dimension or proportion of components of the touch substrate and the display device.

Although relevant touch substrate and the display device containing the same are both provided thereon with an IM film (i.e., index matching film) so as to decrease reflectance of a touch panel for implementing a pattern blanking, it is required that the reflectance of the touch panel should meet even higher requirement(s) for display. In order to solve a problem of how to decrease reflectance of a touch panel so as to decrease effects applied by an ambient light on display frames, both a touch substrate and a display device are provided in embodiments of the disclosure.

FIG. 1 illustrates a structural schematic view of a touch substrate provided in embodiments of the disclosure. As illustrated in FIG. 1, according to a general technical concept of embodiments of the present disclosure, there is provided a touch substrate, comprising: a base substrate 10; a first pattern blanking layer 20, provided on the base substrate 10; and a touch layer 30, provided between the base substrate 10 and the first pattern blanking layer 20, and a second pattern blanking layer 40 provided at a side of the touch layer 30 facing away from the base substrate 10.

The base substrate 10 is formed by a transparent material, which is for example but not limited to glass or resin.

The touch layer 30 comprises touch electrodes and lead wires connected with the touch electrodes, each of which may be manufactured by a transparent conductive material, e.g., ITO (Indium Tin Oxide).

For example, in embodiments of the disclosure, both the first pattern blanking layer and the second pattern blanking layer are provided on opposite two sides of the touch layer respectively, further increasing transmittance of the touch layer as compared with a condition in which a pattern blanking layer or pattern blanking layers may be provided on only one side of a touch layer in a relevant touch panel, such that the touch layer 30 becomes more elusive (i.e., hardly be perceived) in visible light, and any influence on display frames as applied by reflected light from the touch layer may also be decreased.

In specific embodiments, for example, the first pattern blanking layer 20 is in a periodic structure comprising at least a group of pattern blanking sub-layers, and each group of pattern blanking sub-layers of the first pattern blanking layer 20 comprises a first pattern blanking sub-layer 21 and a second pattern blanking sub-layer 22 overlapped with each other. The expression “periodic structure” means that, in a condition a periodicity (i.e., cycle number or period number) is larger than 1, i.e., in a condition that the first pattern blanking layer comprises at least two groups of pattern blanking sub-layers, the first pattern blanking sub-layers 21 in different groups of the pattern blanking sub-layers of the first pattern blanking layer 20 are identical in their respective materials, and the second pattern blanking sub-layers 22 in different groups of the pattern blanking sub-layers of the first pattern blanking layer 20 are identical in their respective materials. With such a periodic structure, only two kinds of materials are required to manufacture the first pattern blanking layer 20, facilitating the manufacturing.

In specific embodiments, for example, as illustrated in FIG. 1, the first pattern blanking layer 20 comprises only one first pattern blanking sub-layer 21 and only one second pattern blanking sub-layer 22 overlapped with/stacked upon each other. A refractive index of the first pattern blanking sub-layer 21 is larger than that of the second pattern blanking sub-layer 22, and the first pattern blanking sub-layer 21 is arranged closer to the base substrate 10 than the second pattern blanking sub-layer 22. Since there is a difference between the refractive indices of the first pattern blanking sub-layer 21 and the second pattern blanking sub-layer 22, then reflected light may be diminished based on a principle of destructive interference of light, such that the touch layer 30 may be invisible in the visible light.

In specific embodiments, for example, each first pattern blanking sub-layer 21 of the first pattern blanking layer 20 is a NbO layer, and each second pattern blanking sub-layer 22 of the first pattern blanking layer 20 is a SiO₂ layer. Both NbO and SiO₂ are transparent materials, which may decrease absorption of light in a condition that light ray transmits therethrough. The refractive index of NbO is for example 2.3, and the refractive index of SiO₂ is for example 1.47.

Furthermore, thicknesses of the NbO layer and the SiO₂ layer may influence reflectance and transmittance of the first pattern blanking layer 20 for light of different wavelengths. In specific embodiments, a practical thickness (also referred to as geometric thickness or physical thickness) of each first pattern blanking sub-layer 21 of the first pattern blanking layer 20 is for example 40-140 angstrom and the geometric thickness of each second pattern blanking sub-layer 22 of the first pattern blanking layer 20 is for example 350˜450 angstrom. With such a configuration of geometric thicknesses, the first pattern blanking layer 20 has a relatively low reflectance and a relatively high transmittance for a light whose wavelength is in the order of 550 nm.

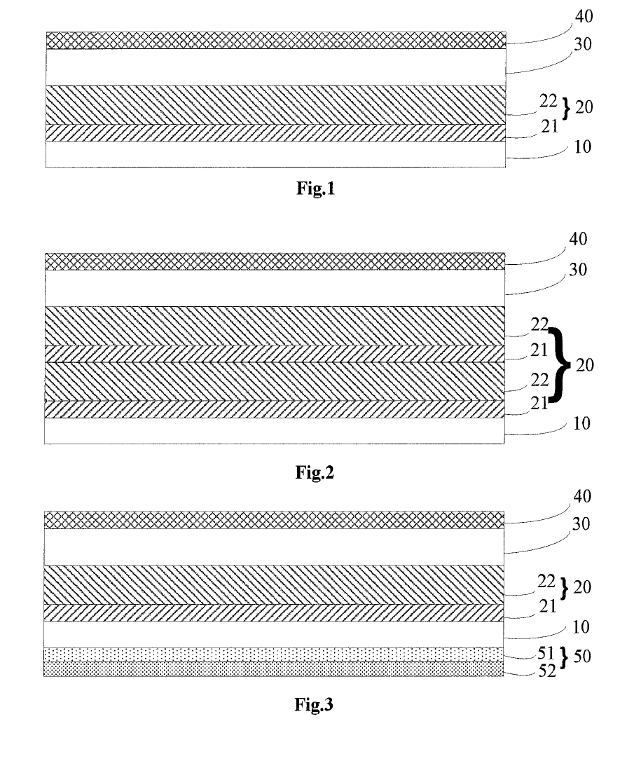

FIG. 2 illustrates a structural schematic view of another touch substrate provided in embodiments of the disclosure. The touch substrate as illustrated in FIG. 2 is mostly the same as that as illustrated in FIG. 1, in their respective structures, only differing in that: the first pattern blanking layer 20 of the touch substrate as illustrated in FIG. 2 comprises two groups of pattern blanking sub-layers stacked on/overlapped with each other, each group of pattern blanking sub-layers comprising a first pattern blanking sub-layer 21 and a second pattern blanking sub-layer 22, and the two groups of pattern blanking sub-layers differing from each other in their geometric thicknesses. Since one group of pattern blanking sub-layers may only enhance the transmittance of light within a certain wavelength range and decrease correspondingly the reflectance thereof, then, two groups of pattern blanking sub-layers are provided, whose geometric thicknesses are set to be different from each other (with a ratio between geometric thicknesses of the first pattern blanking sub-layer and the second pattern blanking sub-layer in each group of pattern blanking sub-layers remaining unchanged), such that optical thicknesses of the two groups of pattern blanking sub-layers also differ from each other. There is a conversion relationship between optical thickness and physical/geometric thickness, i.e., Optical Thickness=Geometric Thickness*Refractive Index Ratio of Medium. By changing optical thicknesses of two groups of pattern blanking sub-layers, a wavelength range in which the transmittance of light is increased and the reflectance of light is decreased may become much wider, as compared with an optical wavelength range in which the transmittance is increased significantly in a condition of only a single group of pattern blanking sub-layers.

In other embodiments, for example, the first pattern blanking layer 20 further comprises more groups of pattern blanking sub-layers overlapped with one another. By way of example, in a condition that the first pattern blanking layer 20 comprises at least two groups of pattern blanking sub-layers, the first pattern blanking sub-layers 21 in different groups of the pattern blanking sub-layers of the first pattern blanking layer 20 are identical in their respective refractive indices and are different from one another in their respective geometric thicknesses, and the second pattern blanking sub-layers 22 in different groups of the pattern blanking sub-layers of the first pattern blanking layer 20 are identical in their respective refractive indices and are different from one another in their respective geometric thicknesses. Each group of pattern blanking sub-layers of the first pattern blanking layer 20 comprises a first pattern blanking sub-layer 21 and a second pattern blanking sub-layer 22 which may be provided to be overlapped with each other, the refractive index of each first pattern blanking sub-layer 21 being larger than the refractive index of each second pattern blanking sub-layer 22. And in each group of pattern blanking sub-layers, the first pattern blanking sub-layer 21 is a pattern blanking sub-layer which is arranged nearest/closest to the base substrate, i.e., the first pattern blanking sub-layer is arranged closer to the base substrate than the second pattern blanking sub-layer. Since various first pattern blanking sub-layers 21 are identical in their respective refractive indices and various second pattern blanking sub-layers 21 are also identical in their respective refractive indices, therefore, geometric thicknesses of both the first pattern blanking sub-layer 21 and the second pattern blanking sub-layer 22 in each group of pattern blanking sub-layers may be changed, such that optical thicknesses of various groups of pattern blanking sub-layers also differ from one another; and then a wavelength range in which the transmittance of light is increased and the reflectance of light is decreased may become much wider, as compared with an optical wavelength range in which the transmittance is increased significantly in a condition of only a single group of pattern blanking sub-layers. Since the optical thickness is equal to the product of corresponding geometric thickness by refractive index, therefore, the optical thickness may be adjusted by changing at least one of the refractive index and corresponding geometric thickness. And since the refractive index is related to both material and processes, then, by remaining the refractive index unchanged and only changing specific geometric thickness, the optical thickness of each group of pattern blanking sub-layers may be changed accordingly, with relatively simple processes and a convenient manufacturing.

In the touch substrate as illustrated in FIG. 1 or FIG. 2, the second pattern blanking layer 40 is for example a structure of a single layer. Since light may be reflected at an interface between two adjacent layers when it transmits through various layers of the touch substrate, and may be reflected even stronger at a side of the interface nearer to an incident side of light, then, in a condition that the first pattern blanking is provided in above periodic structure, it is more convenient to enhance transmittance of light at the interface between the touch layer 30 and the base substrate 10, in other words, the reflection of light at the interface between the touch layer 30 and the base substrate 10 is decreased, as compared with another condition in relevant technologies in which there is only one pattern blanking layer. And the touch substrate may be further provided with above second pattern blanking layer 40 in a structure of a single layer, such that the transmittance of the touch substrate may be further increased and an overall geometric thickness of the touch substrate may be further decreased.

Specifically, the second pattern blanking layer 40 is for example a SiON layer. SiON is a transparent material having a refractive index of 1.65.

Furthermore, for example, the geometric thickness of the second pattern blanking layer 40 is 650˜750 angstrom. A SiON layer having a thickness in such a thickness range may have a relatively low reflectance and a relatively high transmittance for a light whose wavelength is in the order of 550 nm.

Moreover, the second pattern blanking layer 40 is for example further provided with an OCA (i.e., Optical Clear Adhesive) layer additionally at a side thereof facing away from the touch layer 30, facilitating adhesion between the touch substrate and a display module.

FIG. 3 illustrates a structural schematic view of one more another touch substrate provided in embodiments of the disclosure. The touch substrate as illustrated in FIG. 3 is mostly the same as that as illustrated in FIG. 1, in their respective structures, only differing in that: the touch substrate as illustrated in FIG. 3 further comprises a transmittance enhancement layer 50 which is provided on the base substrate 10 at a side thereof opposite to the first pattern blanking layer 20, i.e., each of the transmittance blanking layer 50 an the first pattern blanking layer 20 is located respectively on a surface at a corresponding one of both sides of the base substrate 10. By providing the transmittance enhancement layer 50 on the base substrate, the reflection of both ambient light and incident light by the base substrate 10 may be further decreased, and the transmittance of the base substrate 10 may be further increased, so as to improve display effect of pictures/display frames. Meanwhile, since the touch panel may essentially operate in a condition that the screen is switched off (i.e., there is no incident light presenting any display contents) once the reflection (especially for the ambient light) is decreased, then reflected ambient light is also decreased accordingly, such that it may be perceived by human eyes that the display area of the touch panel may become even darker and the display area and a non-display area (which comprises a BM (black matrix) region and a bezel region) may have similar brightness/luminance, facilitating implementation of an integral and uniform degree of black color at both panel and bezel of the display device, and enhancing aesthetics thereof; moreover, the light emission by the panel in the condition that the screen is switched off may also be decreased so as to facilitate manufacturing of a non-glossy screen.

Upon implementation, the transmittance enhancement layer 50 for example in a periodic structure comprising at least a group of transmittance enhancement sub-layers, each group of the transmittance enhancement sub-layers comprises a first transmittance enhancement sub-layer 51 and a second transmittance enhancement sub-layer 52. The expression “periodic structure” means that, in a condition a periodicity (i.e., cycle number or period number) is larger than 1, i.e., in a condition that the transmittance enhancement layer comprises at least two groups of transmittance enhancement sub-layers, the first transmittance enhancement sub-layers 51 in different groups of the transmittance enhancement sub-layers of the transmittance enhancement layer 50 are identical in their respective materials, and the second transmittance enhancement sub-layers 52 in different groups of the transmittance enhancement sub-layers of the transmittance enhancement layer 50 are identical in their respective materials. With such a periodic structure, only two kinds of materials are required to manufacture the transmittance enhancement layer 50, facilitating the manufacturing.

As illustrated in FIG. 3, the transmittance enhancement layer 50 for example comprises a first transmittance enhancement sub-layer 51 and a second transmittance enhancement sub-layer 52 overlapped with each other, the refractive index of the first transmittance enhancement sub-layer 51 of the transmittance enhancement layer 50 being larger than the refractive index of the second transmittance enhancement sub-layer 52 of the transmittance enhancement layer 50, and the first transmittance enhancement sub-layer 51 of the transmittance enhancement layer being arranged closer to the base substrate 10 as compared with the second transmittance enhancement sub-layer 52. Since there is a difference between the refractive indices of the first pattern blanking sub-layer 51 and the second pattern blanking sub-layer 52, then there also exists a phase difference between reflected light on surfaces of the first transmittance enhancement sub-layer 51 and the second transmittance enhancement sub-layer 52; as such, reflected light may be diminished and transmittance may be increased, based on a principle of destructive interference of light.

Specifically, each first transmittance enhancement sub-layer 51 of the transmittance enhancement layer 50 is a NbO layer, and each second transmittance enhancement sub-layer 52 of the transmittance enhancement layer 50 is a SiO₂ layer. Both NbO and SiO₂ are transparent materials, which may decrease absorption of light by the transmittance enhancement layer 50 in a condition that light ray transmits therethrough.

Furthermore, in embodiments of the disclosure, the geometric thickness of each first transmittance enhancement sub-layer 51 of the transmittance enhancement layer 50 is for example 900˜1000 angstrom and the geometric thickness of each second transmittance enhancement sub-layer 52 of the transmittance enhancement layer 50 is for example 800˜900 angstrom.

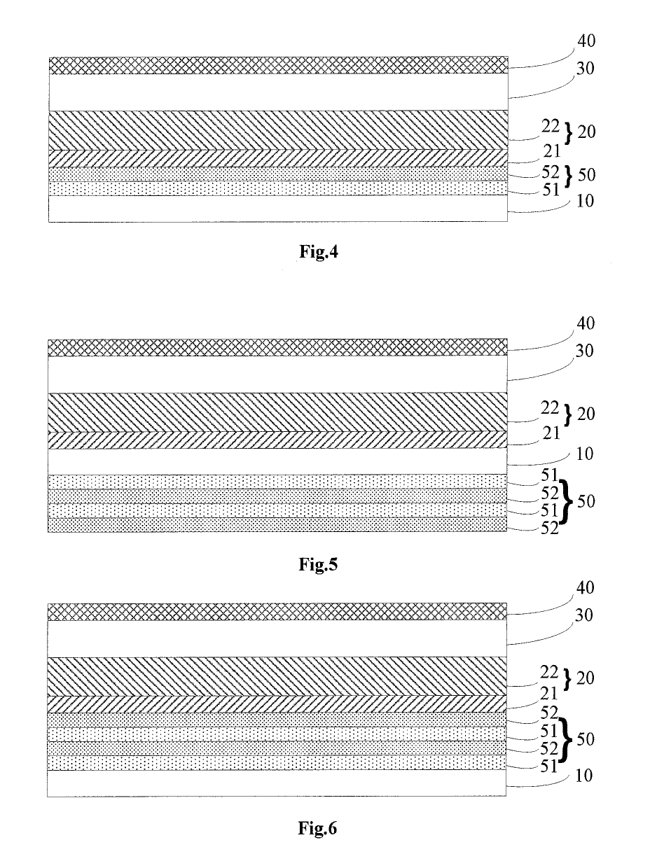

FIG. 4 illustrates a structural schematic view of still another touch substrate provided in embodiments of the disclosure. The touch substrate as illustrated in FIG. 4 is mostly the same as that as illustrated in FIG. 3, in their respective structures, only differing in that: in the touch substrate as illustrated in FIG. 4, the transmittance enhancement layer 50 is provided on the base substrate, on a surface thereof at a same side as the first pattern blanking layer 20, and is located between the first pattern blanking layer 20 and the base substrate 10.

FIG. 5 illustrates a structural schematic view of yet another touch substrate provided in embodiments of the disclosure. The touch substrate as illustrated in FIG. 5 is mostly the same as that as illustrated in FIG. 3, in their respective structures, only differing in that: in the touch substrate as illustrated in FIG. 5, the transmittance enhancement layer 50 comprises two groups of transmittance enhancement sub-layers overlapped with each other, the two groups differing in their geometric thicknesses; and each group of transmittance enhancement sub-layers of the transmittance enhancement layer 50 comprises a first transmittance enhancement sub-layer 51 and a second transmittance enhancement sub-layer 52 overlapped with each other. Since one group of transmittance enhancement sub-layers may only enhance the transmittance of light within a certain wavelength range and decrease correspondingly the reflectance, then, two groups of transmittance enhancement sub-layers are provided, whose geometric thicknesses are set to be different from each other, such that optical thicknesses of the two groups of transmittance enhancement sub-layers also differ from each other. By changing optical thicknesses of two groups of transmittance enhancement sub-layers, a wavelength range in which the transmittance of light is increased and the reflectance of light is decreased may become much wider, as compared with an optical wavelength range in which the transmittance is increased significantly in a condition of only a single group of transmittance enhancement sub-layers. By providing two groups of transmittance enhancement sub-layers, the transmittance enhancement layer may not only have both a relatively high transmittance and a relatively low reflectance, but also have a decreased number of layers overlapped mutually, facilitating manufacturing thereof.

Furthermore, by way of example, the geometric thickness of each first transmittance enhancement sub-layer 51 is 140˜240 angstrom, and the geometric thickness of each second pattern blanking sub-layer 52 is 190˜290 angstrom, in a first group of the transmittance enhancement sub-layers of the transmittance enhancement layer 50; and the geometric thickness of each first transmittance enhancement sub-layer 51 is 1080˜1180 angstrom, and the geometric thickness of each second pattern blanking sub-layer 52 is 780˜880 angstrom, in a second group of the transmittance enhancement sub-layers of the transmittance enhancement layer 50. And the first group of the transmittance enhancement sub-layers of the transmittance enhancement layer 50 is a group of the transmittance enhancement sub-layers arranged nearest/closest to the base substrate 10, i.e., the first group of the transmittance enhancement sub-layers are arranged closer to the base substrate 10 as compared with the second group of the transmittance enhancement sub-layers. With such a configuration of geometric thicknesses, the transmittance enhancement layer 50 may have an improved transmittance and a decreased reflectance as compared with the base substrate 10, facilitating further improvement on display effect of image frames, such that the display area and a non-display area of the touch panel may have similar brightness/luminance in a condition that the screen is switched off, further facilitating manufacturing of non-glossy screen.

By providing the first pattern blanking layer 20, the second pattern blanking layer 40, the transmittance of the touch layer 30 may be increased and the reflectance of the touch layer 30 may be decrease accordingly; and by providing the transmittance enhancement layer 50, the transmittance of the base substrate 10 may also be increased and the reflectance of the base substrate 10 may be decrease accordingly. Moreover, By providing the first pattern blanking layer 20, the second pattern blanking layer 40, and the transmittance enhancement layer 50 comprising two groups of transmittance enhancement sub-layers simultaneously, such that a transmittance of the touch substrate for a visible light having a wavelength of 550 nm may be more than 94%, 550 nm being at an intermediate location in a visible light band. In a condition that the transmittance for a visible light having a wavelength of 550 nm is more than 94% and the reflection for such visible light is less than 5%, then in the visible light band, for a visible light having a wavelength in proximity of 550 nm, there may be a relatively high transmittance, which is favorable for enhancement of display effect of display frames.

In other embodiments, the transmittance enhancement layer 50 is for example in a periodic structure having more groups of transmittance enhancement sub-layers. In a condition that the transmittance enhancement layer 50 may comprise at least two groups of transmittance enhancement sub-layers, the first transmittance enhancement sub-layers 51 of different groups of transmittance enhancement sub-layers of the transmittance enhancement layer 50 are identical in their respective refractive indices and are different from one another in their respective geometric thicknesses, and the second transmittance enhancement sub-layers 52 of different groups of transmittance enhancement sub-layers of the transmittance enhancement layer 50 are identical in their respective refractive indices and are different from one another in their respective geometric thicknesses. Each group of the transmittance enhancement sub-layers of the transmittance enhancement layer 50 may comprise a first transmittance enhancement sub-layer 51 and a second transmittance enhancement sub-layer 52 overlapped with each other, the refractive index of each first transmittance enhancement sub-layer 51 of the transmittance enhancement layer 50 being larger than the refractive index of each second transmittance enhancement sub-layer 52 of the transmittance enhancement layer 50. Since the first transmittance enhancement sub-layers 51 of the transmittance enhancement layer 50 are identical in their respective refractive indices, and the second transmittance enhancement sub-layers 52 of the transmittance enhancement layer 50 are also identical in their respective refractive indices, therefore, the geometric thicknesses of both the first transmittance enhancement sub-layers 51 and the second transmittance enhancement sub-layers 52 may be changed such that various groups of transmittance enhancement sub-layers differ in their respective optical thicknesses, resulting in an even larger wavelength range in which the transmittance for light is increased and the reflectance for light is decreased. The optical thickness may be adjusted by changing at least one of the refractive index and the corresponding geometric thickness; and since the refractive index is related to both material and processes, then, by remaining the refractive index unchanged and only changing specific geometric thickness, the optical thickness of each group of transmittance enhancement sub-layers may be changed accordingly, with relatively simple processes and a convenient manufacturing, as compared with another condition in which the refractive index is changed, facilitating manufacturing thereof.

And since various groups of transmittance enhancement sub-layers differ in their respective geometric thicknesses, their respective optical thicknesses also differ from one another, such that in this condition a wavelength range in which the transmittance of light is increased and the reflectance of light is decreased may become much wider, as compared with an optical wavelength range in which the transmittance is increased significantly in a condition of only a single group of pattern blanking sub-layers.

FIG. 6 illustrates a structural schematic view of still yet another touch substrate provided in embodiments of the disclosure. The touch substrate as illustrated in FIG. 6 is mostly the same as that as illustrated in FIG. 7, in their respective structures, only differing in that: in the touch substrate as illustrated in FIG. 6, the transmittance enhancement layer 50 is provided on the base substrate 10, on a surface thereof at a side next to the touch layer 30, i.e., provided between the base substrate 10 and the first pattern blanking layer 20.

It should be noticed that, although the first pattern blanking layer 20 in either touch substrate as illustrated in FIG. 5 and FIG. 6 comprises only one group of transmittance enhancement sub-layers, in other alternative embodiments, the first pattern blanking layer 20 for example comprises two or more groups of transmittance enhancement sub-layers, without being limited in embodiments of the disclosure.

When the touch substrate as provided in the embodiments of the disclosure is being manufactured, the first pattern blanking layer 20, the second pattern blanking layer 40 and the transmittance enhancement layer 50 may all be manufactured by sputtering coating.

In another aspect of embodiments of the disclosure, a display device is provided, comprising any one touch substrate as above.

The display device may be any one of: a mobilephone, a tablet computer, a television set, a display, a laptop computer, a digital photo frame, a navigator, and any other product or component having display functionality. Other necessary components of the display device may be known to those skilled in the art and will not be set forth in detail herein, without functioning as any limitation on embodiments of the disclosure.

There are several beneficial technical effects brought about by the technical solutions of embodiments of the disclosure, as listed below:

In embodiments of the disclosure, by providing a first pattern blanking layer and a second pattern blanking layer on two opposite sides of a touch layer respectively, the transmittance of the touch layer may be further increased so as to decrease influence on image frames as applied by the reflected light at the touch layer, as compared with a touch panel in relevant technologies which is provided with a pattern blanking layer at only a single side of the touch layer.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although the disclosure is described in view of the attached drawings, the embodiments disclosed in the drawings are only intended to illustrate the preferable embodiment of the present disclosure exemplarily, and should not be deemed as a restriction thereof.

Although several exemplary embodiments of the general concept of the present disclosure have been shown and described, it would be appreciated by those skilled in the art that various changes or modifications may be made in these embodiments without departing from the principles and spirit of the disclosure and lie within the scope of present application, which scope is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is,:

1. A touch substrate, comprising:
a base substrate;
a first pattern blanking layer, provided on the base substrate; and
a touch layer, provided between the base substrate and the first pattern blanking layer,
wherein the touch layer is further provided at a side thereof facing away from the base substrate a second pattern blanking layer.

2. The touch substrate according to claim 1, wherein the first pattern blanking layer is in a periodic structure comprising at least a group of pattern blanking sub-layers, the second pattern blanking layer being a structure of a single layer.

3. The touch substrate according to claim 2, wherein each group of pattern blanking sub-layers of the first pattern blanking layer comprises a first pattern blanking sub-layer and a second pattern blanking sub-layer overlapped with each other, the refractive index of each first pattern blanking sub-layer being larger than the refractive index of each second pattern blanking sub-layer; and
wherein in each group of pattern blanking sub-layers, the first pattern blanking sub-layer is arranged closer to the base substrate as compared with the second pattern blanking sub-layer.

4. The touch substrate according to claim 3, wherein in a condition that the first pattern blanking layer comprises at least two groups of pattern blanking sub-layers, the first pattern blanking sub-layers in different groups of the pattern blanking sub-layers of the first pattern blanking layer are identical in their respective refractive indices and are different from one another in their respective geometric thicknesses, and the second pattern blanking sub-layers in different groups of the pattern blanking sub-layers of the first pattern blanking layer are identical in their respective refractive indices and are different from one another in their respective geometric thicknesses.

5. The touch substrate according to claim 3, wherein each first pattern blanking sub-layer of the first pattern blanking layer is a NbO layer, and each second pattern blanking sub-layer of the first pattern blanking layer is a SiO₂ layer.

6. The touch substrate according to claim 5, wherein the geometric thickness of each first pattern blanking sub-layer of the first pattern blanking layer is 40˜140 angstrom, and the geometric thickness of each second pattern blanking sub-layer of the first pattern blanking layer is 350˜450 angstrom.

7. The touch substrate according to claim 2, wherein the second pattern blanking layer is a SiON layer.

8. The touch substrate according to claim 7, wherein the geometric thickness of the second pattern blanking layer is 650˜750 angstrom.

9. The touch substrate according to claim 1, wherein there is provided additionally a transmittance enhancement layer on the base substrate, the transmittance enhancement layer being located on a surface at a side of the base substrate.

10. The touch substrate according to claim 1, wherein the transmittance enhancement layer is provided on the base substrate, on a surface thereof at a same side as the first pattern blanking layer, and is located between the first pattern blanking layer and the base substrate.

11. The touch substrate according to claim 1, wherein the transmittance enhancement layer is provided on the base substrate, on a surface thereof at a side opposite to the first pattern blanking layer.

12. The touch substrate according to claim 9, wherein the transmittance enhancement layer is in a periodic structure comprising at least a group of transmittance enhancement sub-layers, each group of the transmittance enhancement sub-layers comprises a first transmittance enhancement sub-layer and a second transmittance enhancement sub-layer overlapped with each other, the refractive index of each first transmittance enhancement sub-layer of the transmittance enhancement layer being larger than the refractive index of each second transmittance enhancement sub-layer of the transmittance enhancement layer, and
wherein in each group of transmittance enhancement sub-layers, the first transmittance enhancement sub-layer of the transmittance enhancement layer is arranged closer to the base substrate as compared with the second transmittance enhancement sub-layer.

13. The touch substrate according to claim 12, wherein in a condition that the transmittance enhancement layer comprises at least two groups of transmittance enhancement sub-layers, the first transmittance enhancement sub-layers of different groups of transmittance enhancement sub-layers of the transmittance enhancement layer are identical in their respective refractive indices and are different from one another in their respective geometric thicknesses, and the second transmittance enhancement sub-layers of different groups of transmittance enhancement sub-layers of the transmittance enhancement layer are identical in their respective refractive indices and are different from one another in their respective geometric thicknesses.

14. The touch substrate according to claim 12, wherein each first transmittance enhancement sub-layer of the transmittance enhancement layer is a NbO layer, and each second transmittance enhancement sub-layer of the transmittance enhancement layer is a SiO₂ layer.

15. The touch substrate according to claim 14, wherein the transmittance enhancement layer comprises two groups of transmittance enhancement sub-layers.

16. The touch substrate according to claim 15, wherein the geometric thickness of each first transmittance enhancement sub-layer is 140˜240 angstrom, and the geometric thickness of each second pattern blanking sub-layer is 190˜290 angstrom, in a first group of the transmittance enhancement sub-layers of the transmittance enhancement layer,
wherein the geometric thickness of each first transmittance enhancement sub-layer is 1080˜1180 angstrom, and the geometric thickness of each second pattern blanking sub-layer is 780˜880 angstrom, in a second group of the transmittance enhancement sub-layers of the transmittance enhancement layer, and
wherein the first group of the transmittance enhancement sub-layers are arranged closer to the base substrate as compared with the second group of the transmittance enhancement sub-layers.

17. A display device, comprising:
the touch substrate according to claim 1.
